(19) United States
(12) Patent Application Publication
(10) Pub. No.: US 2012/0027171 A1
(43) Pub. Date: Feb. 2, 2012

(54) HIGH SPEED SCANNING OF LARGE OBJECTS USING RADIATION

(76) Inventor: SATPAL SINGH, Potomac, MD (US)

(21) Appl. No.: 12/845,793

(22) Filed: Jul. 29, 2010

(51) Int. Cl. G01N 23/04

(52) U.S. Cl. 378/57

(57) ABSTRACT

This invention describes a novel beam arrangement for multiview and dual view x-ray or radiation scanning systems used for inspection of objects. The method described herein is especially suited for scanning large objects such as palletized cargo or dense objects that are longer in one dimension, for example the height being larger than the width or depth. As the size and density of the object to be scanned increase, the absorption of the x-rays by the object increases with less of x-rays reaching the detectors. Therefore, in order to receive minimal signal for acceptable image quality, the scan speed is slowed which for certain objects it might become so low that it may not be acceptable. This invention describes a novel beam arrangement that greatly speeds up the scan speed.

### BACKGROUND OF THE INVENTION

1. Field of the Invention

This invention describes a method of using x-rays or radiation to inspect an object or a parcel. This method is specially suited for large objects such as palletized cargo.

2. Description of the Related Art

X-ray scanning is used for inspection of baggage and cargo at airports, at ports of entries, at entry points of facilities and buildings, at check points and at various other places where security demands. The scanning of larger cargo or palletized cargo is often done by x-ray machines that have either a single or dual sources of x-ray. In a single view machine, a single source of x-ray is used, it emits a fan shaped beam which penetrates through the object being scanned and is detected by the detectors at the opposite end of the x-ray source. Often a single scan image thus obtained is not sufficient to examine the contents of the cargo, therefore a second source of x-ray is used that directs it beam at ninety degrees to the first to get a second view of the object.

A simplified schematic of a cross section of a typical palletized cargo scanner according to prior art is shown in FIG. 1. It comprises of a first x-ray source 50 that emits a first fan shaped radiation beam, 51, in the horizontal direction, a second x-ray source 60 that emits a second fan shaped radiation beam, 61, in the vertical detection, the horizontal and vertical beams intersect a space occupied by a tunnel 70 through which the object 80 to be scanned is translated.

The speed with which the object or cargo is scanned relative to the x-rays depends on the material properties of the object. If the object is higher density with higher coefficient of absorption as is the case with seafood compared to a low density cargo of flowers, then very little x-rays penetrate through the cargo to reach the detectors. In order for sufficient x-ray photons to be collected at the detector, the scanning speed is slowed down. For palletized cargo, the scan speed is often slowed down to less than fifteen pallets per hour and even much slower for cargo that is of higher density. This slows down the commerce and results in large indirect financial loss. Therefore the object of this invention is to provide a method of scanning at high speeds.

The use of a second source requires a second x-ray generator of high energy along with its high voltage generator and associated housing. This results in extra cost. Therefore an additional object of this invention is to use a single source and reduce the cost.

Another problem with dual source x-ray systems with the second source located on top of the tunnel is that the height of the scanning machine is large. As an example, most of the machines used for scanning pallets 48 inches wide and 60 inches high have a tunnel that is 60 inches wide and 65 inches high. The location of the second source on top of the tunnel that is 65 inches tall results in a overall height of such machines in the range of ten to more than twelve feet. This is higher than most ceilings which are just 8 feet, therefore the use of such machines often requires facilities modifications which results in a substantial additional or installation costs. Therefore another object of this invention is to build a system that is lower in height.

Accordingly, the objects of this invention are to overcome the above limitations as stated next.

### OBJECTS OF THE INVENTION

It is, accordingly, an object of the invention to provide a method of scanning large objects or palletized cargo at high speeds.

It is also an object of this invention to build a relatively compact scanner that is less than 8 ft high which is the height of ceilings in most buildings in USA, thereby avoiding costly facilities modifications and excessive installation costs.

It is also an object of this invention to use a single radiation source so that costs can further be reduced.

These and other objects will become apparent in the description that follows.

### SUMMARY OF THE INVENTION

A dual view x-ray system for inspection of cargo is presented. The system described in this invention uses a novel beam arrangement that results in high speed scans of tall palletized cargo, has a low height that can easily fit in rooms with ceilings of 8 ft, and uses a single x-ray or radiation source thereby resulting in low cost.

According to the method of this invention, the object or the cargo is translated through a tunnel where it is illuminated by two beams that are at right angle to each other and at 45 degrees to the direction of translation of the object, further for a rectangular pallet or object, the object is rotated 45 degrees before it is translated through the tunnel. This 45 degree rotation of the object results in minimal path of the x-rays through the object and hence minimal absorption of x-rays by the object. The x-ray source used is located near the floor level and emits radiation in the horizontal direction. The x-ray source has a collimator so that two fan shaped beams are generated which are at 90 degrees to each other. The placement of the x-ray source at floor level leads to a low height of the scanning system. This arrangement of the x-ray source and radiation beams results in high speed scans for objects that are taller than their transverse dimensions.

There are several embodiments, objects and advantages to this invention that will be apparent to one skilled in the art. The accompanying figures and description herein should be considered illustrative only and not limiting or restricting the scope of invention, the scope being indicated by the claims.

### BRIEF DESCRIPTION OF THE DRAWINGS

FIG. 1 shows the simplified schematic of prior art of a two view system with one horizontal beam and one vertical beam.

FIG. 2 shows a simplified schematic of the preferred embodiment of the current invention.

FIG. 3 shows a top view of the preferred embodiment shown in FIG. 2.

FIG. 4 shows an alternate embodiment using two radiation sources, this arrangement leads to shorter tunnel length.

FIG. 5 shows another alternate embodiment of current invention, it uses two beams perpendicular to the direction of the motion and a turn table to rotate the object by ninety degrees.

### DETAILED DESCRIPTION OF THE PREFERRED EMBODIMENTS

In describing the preferred embodiment and its alternatives, specific terminology will be used for the sake of clarity. However, the invention is not limited to the specific terms so used, and it should be understood that each specific term includes all its technical equivalents which operate in a similar manner to accomplish similar purpose.

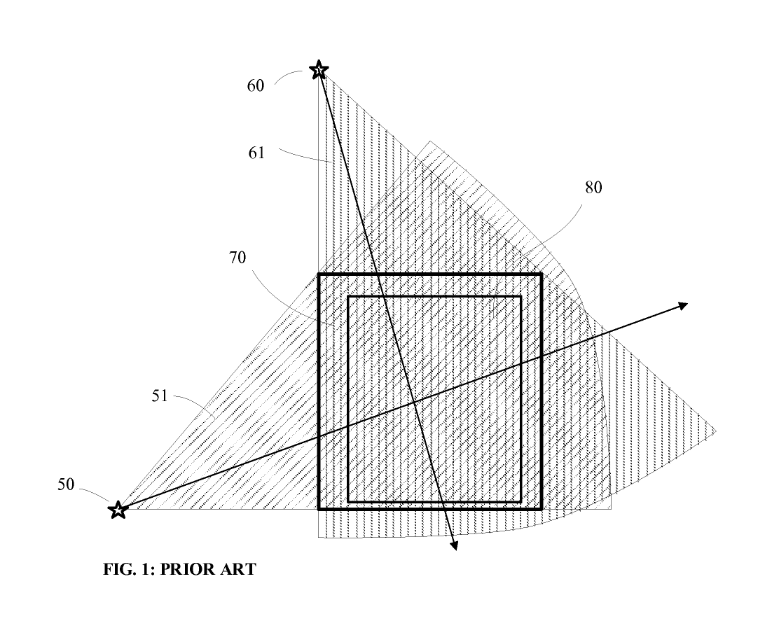

In order to understand the physics behind the novel method of this invention, reference is made to the prior art of FIG. 1 which shows a dual view system. Consider a typical requirement for pallet scanning that be able to scan pallets of 48 inches wide and 60 inches tall. Then with reference to FIG. 1, the vertical beam 61 has to pass through at least the height or 60 inches of object, whereas the horizontal beam 51 passes through the width of pallet or 48 inches of object. Since the vertical beam 61 passes through a greater length of the object, it is absorbed more than the horizontal beam, as a result the image quality suffers for the vertical beam. In order to improve the quality of the image produced by the vertical beam, the speed with which the object is scanned needs to be reduced so that more x-ray photons can reach the detector. For low density object, the speed may not have to be decreased at all, but for higher density objects which have higher absorption of the x-rays, the speed may have to be decreased a lot, and for those cases where the density is high enough, there is complete absorption of the x-rays and no meaningful image is produced no matter how slow the speed.

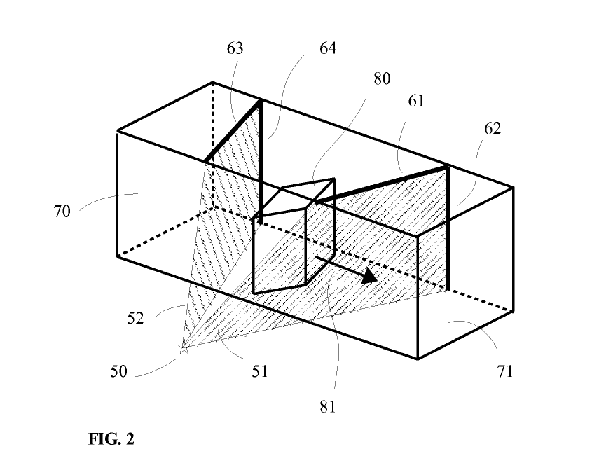

Therefore, according to the method of this invention, the second view is not obtained using a vertical beam, instead both the views are obtained with beams being horizontal but at right angles to each other as shown in FIG. 2.

FIG. 2 shows a preferred embodiment of the present invention. For the sake of clarity in the drawings, the ordinary details relating to the mechanics and electronics of the system have been omitted as these are well known to a person skilled in the field.

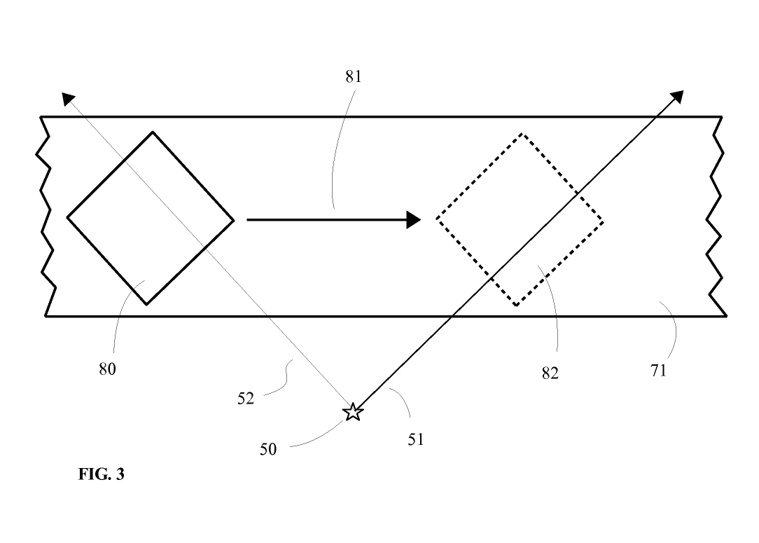

With reference to FIG. 2, the object 80 to be inspected is translated through a tunnel 70 in the direction of translation or motion as indicated by the arrow 81. Further, as shown, the object 80 is rectangular as a pallet cargo would normally be, it is rotated forty five degrees so that none of its edges are parallel to the length of the tunnel 70. As the object moves through the tunnel, it is intercepted by two x-ray or radiation beams 51 and 52 emitted from a source 50. The first radiation beam 51 makes an angle of forty five degrees with the direction of motion 81 and is generally in the same direction as the direction of motion or translation. The second radiation beam 52 makes an angle of forty five degrees with the direction of translation or motion 81 but is generally in the direction that is opposite to the direction of motion. A top view of the system of FIG. 2 is shown in FIG. 3. With reference to FIG. 2, the radiation beam 51 is detected by a “L” shaped first detector with detector arms 61 and 62, and the beam 52 is detected by “L” shaped second detector comprising of detector arms 63 and 64. Not shown in the drawing to avoid the clutter are the conveyor means, the motors and the transport mechanism, the computing and display means, and other details which are well known to a person skilled in the field.

FIG. 3 is the top view of the system of FIG. 2 and it further illustrates the beam arrangement. As shown in FIG. 3, both the beams 51 and 52 are horizontal, only one source 50 is used, the object 80 is shown initially illuminated by beam 52, and after it has moved in the direction of the arrow 81 to position 82 shown dotted, it is illuminated by beam 51. Thus as the object 80 moves along the conveyor 71, it gets scanned by the x-rays from two angles that are ninety degrees to each other thus generating a dual views that are orthogonal to each other.

The differentiation of the novel beam arrangement according to this invention from that of the prior art is clearly illustrated by comparing FIG. 1 and FIG. 3. In the prior art of FIG. 1, there is one horizontal beam 51, and one vertical beam 61. The vertical beam passes through extra distance within the object 80 and is heavily attenuated especially if the object 80 has higher density and higher attenuation coefficient, thereby resulting in a poor quality image generated by the vertical beam. In contrast, the beam arrangement of FIG. 2 and FIG. 3, there is no vertical beam, and as shown in FIG. 3, the distances traveled by both the beams 51 and 52 within the object 80 are the same. Since the path lengths of beams 51 and 52 through the object are the same, they are attenuated equally as they pass through the object, and thus result in similar quality of detected signals or images for both the beams.

Further, the arrangement of FIG. 2 and FIG. 3 shows the use of only source in comparison to the two used in prior art of FIG. 1, this results in big power and cost savings as the x-ray generators are the major source of energy consumption in any x-ray scanning system and also one of the costlier components.

It should also be noted that the novel arrangement shown in FIG. 2 and FIG. 3, has no vertical placement of the source, hence the height of the system is low compared to that of the prior art of FIG. 1. Whereas the prior art of FIG. 1 has systems with heights of ten to thirteen feet, the novel arrangement of FIG. 2 has a height of only about eight feet that can be easily installed in rooms with a nominal ceiling height of eight feet, whereas the systems according to prior art need special facilities with high ceilings.

The description given above is a preferred embodiment of the invention, but there are several ramifications possible.

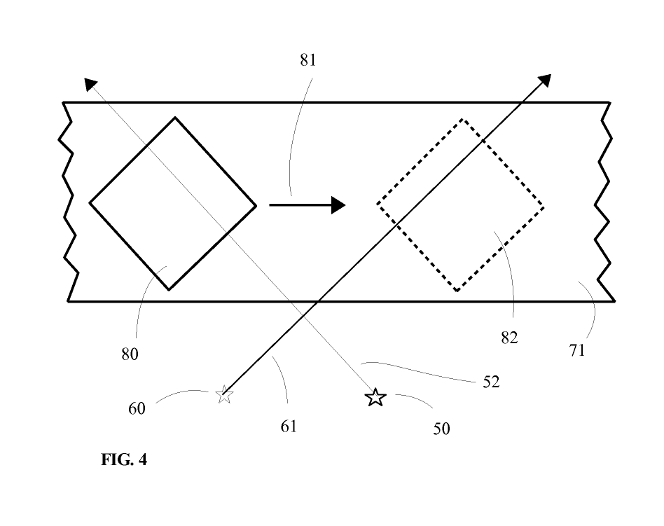

In an alternate embodiment of the invention, a second source 60 is used as shown in FIG. 4. The advantage of this arrangement is that the length of the conveyor 7, and hence of the tunnel 70 shown in FIG. 2, is decreased.

It should be noted that with reference to FIG. 3, it is not necessary for the beams 51 and 52 to be at ninety degrees to each other or be at forty five degrees to the direction of motion 81. As an example, the beam 51 may be at ninety degrees with direction of motion 81, or may be only slightly slanted as for example making an angle of eighty five degrees with the direction of motion 81. Further the beam 52, may make an angle of less than forty five degrees to the orthogonal to the direction of motion 81, that is the angle between beams 51 and 52 could be much less than ninety degrees, additionally, the angle can be greater than ninety degrees as well. The angle between the beams 51 and 52 is not important, it should however be substantial so that the two views give substantially different views or information, further the two views or beams should be horizontal or directed such that the distance traveled through the object by any of the beams is not substantially different or appreciably larger along one beam direction than in the other beam direction.

In another ramification of the method, it should be noted that more than two beams can be used to generate more than two views. For example, with reference to FIG. 3, in addition to beams 51 and 52, there could be another beam that is perpendicular to the direction of motion 81.

In another ramification of the method, it should be noted that the object 80 need not be rotated by forty five degrees before it is put on the conveyor 71.

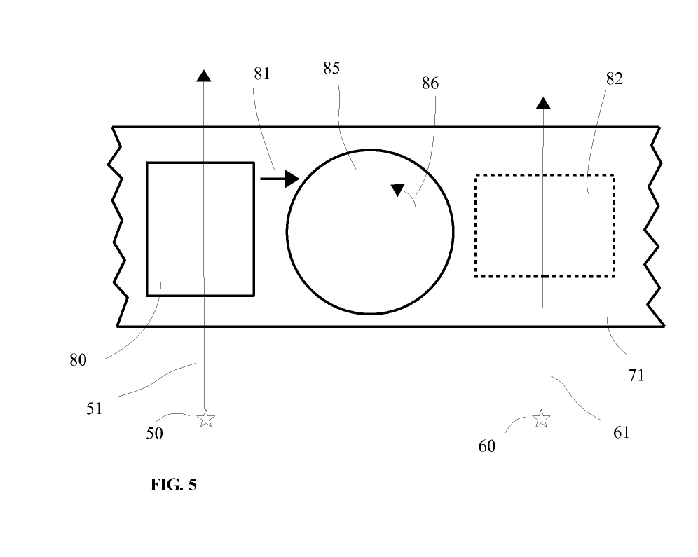

Another embodiment of the invention is shown in FIG. 5. In this embodiment, two sources, 50 and 60 are used that emit beams 51 and 61 respectively that are parallel and orthogonal to the direction of motion 81. The object 80 after it has been scanned by beam 51, moves along the path of motion 81, it reaches over a turn table or a means of rotation 85 which rotates it by ninety degrees so that its in an orientation shown by the dotted lines 82. This results in a scan of object 80 by the beam 61 in a direction that is orthogonal to the first.

As will be apparent to a person skilled in the art, there are several embodiments that can realize the method of this invention which is to scan an object by two beams which are generally in the horizontal direction as this is beneficial when scanning tall objects which result in much larger attenuation along the vertical direction leading to a poor quality image due to the vertical beam. Stated differently, the object should be oriented such that the difference between the path length of first radiation through the object and the path length of second radiation through the object is minimized or not significant. Thus if the two beams travel equal distances within the object, they suffer equal amounts of attenuation, otherwise the beam with longer path through the object is attenuated much more which could lead to substantial degradation or even total loss of signal detected. It is desired that the orientation of the object relative to the beams is such that the beam with the longer path length through the object is not attenuated significantly by the object compared to the other beam with shorter path length through the object.

It should be noted that it is not necessary to use x-ray sources, instead gamma sources like Cesium 137 or Cobalt 60 or any other suitable radiation source could be used.

Further, as is well known to a person skilled in the art, it is not necessary to translate the object, the object need only be relatively translated to the radiation beams.

In the above description, the details of the means to generate radiation, the means to translate the object, the detectors, the detector electronics, the data acquisition, the image generation, the analysis of detected signals from the detectors, and other details have been omitted as they are well known to a person skilled in the art.

The foregoing description of the invention and its embodiments should be considered as illustrative only of the concept and principles of the invention. The invention may be configured in a variety of ways, shapes and sizes and is not limited to the description above. Numerous applications of the present invention will readily occur to those skilled in the art. Therefore, it is desired that the scope of the present invention not be limited by the description above but by the claims presented herein.

The invention claimed is:

1. A method of inspecting an object with at least two radiation beams comprising the steps of:
using a first radiation beam and detecting it by a first detector;
using a second radiation beam directed at a substantially different angle from said first radiation beam, further detecting said second radiation by a second detector;
orienting said object so that difference between path length of said first radiation through said object and path length of said second radiation through said object is not significant;
relatively translating said object through said first and second radiation beams; and analyzing the signals received by said first and said second detectors.

2. The method of claim 1 wherein:
said first radiation beam and said radiation beam are obtained from a single source.

3. The method of claim 1 wherein:
said step of relatively translating of said object through said first and second radiation beams is along a direction of translation;
said first radiation beam is oriented such that it is directed generally forward in the same direction as said direction of translation; and
said second radiation beam is oriented such that it is directed generally opposite to said direction of translation.

4. The method of claim 2 wherein:
said step of relatively translating of said object through said first and second radiation beams is along a direction of translation;
said first radiation beam is oriented such that it is directed generally forward in the same direction as said direction of translation; and
said second radiation beam is oriented such that it is directed generally opposite to said direction of translation.

5. An apparatus for inspecting an object with at least two radiation beams comprising of:
means of generating a first radiation beam;
a first detector located such as to detect signal due to said first radiation beam;
means of generating a second radiation beam;
a second detector located such as to detect signal due to said second radiation beam;
means to orient said object so that difference between path length of said first radiation through said object and path length of said second radiation through said object is not significant;
means to relatively translate said object through said first and second radiation beams; and
means to analyze the signals received by said first and said second detectors.

6. The apparatus of claim 5 wherein said means of generating said first radiation and
said means of generating said second radiation are one and the same.

7. The apparatus of claim 5 wherein:
said means to relatively translate said object through said first and second radiation beams translates said object along a direction of translation;
said means of generating said first radiation beam emits said first radiation beam such that it is directed generally forward in the same direction as said direction of translation; and
said means of generating said second radiation beam emits said second radiation beam such that it is directed generally opposite to said direction of translation.

8. The apparatus of claim 6 wherein:
said means to relatively translate said object through said first and second radiation beams translates said object along a direction of translation;
said means of generating said first radiation beam emits said first radiation beam such that it is directed generally forward in the same direction as said direction of translation; and
said means of generating said second radiation beam emits said second radiation beam such that it is directed generally opposite to said direction of translation.
